(19) United States
(12) Patent Application Publication
(10) Pub. No.: US 2014/0080351 A1
(43) Pub. Date: Mar. 20, 2014

(54) CONNECTOR

(71) Applicant: HOSIDEN CORPORATION, Yao-shi (JP)

(72) Inventors: Yuta KAWAKAMI, Yao-shi (JP); Daisuke SASAKI, Yao-shi (JP); Takayuki NAGATA, Yao-shi (JP)

(73) Assignee: HOSIDEN CORPORATION, Yao-shi (JP)

(21) Appl. No.: 14/022,591

(22) Filed: Sep. 10, 2013

(30) Foreign Application Priority Data
Sep. 14, 2012 (JP) 2012-203194

(51) Int. Cl. H01R 13/58

(52) U.S. Cl. CPC H01R 13/5804
USPC 439/464

(57) ABSTRACT

The invention provides a connector including a cable, a connecting element connected to the cable, a cable tie having a head and a strap, and a first case having first and second recesses. The strap ties a first end portion of the cable and is engaged in an engaging hole of the head. The first recess extends in an orthogonal direction orthogonal to the length direction of the cable and houses the strap partly. The second recess is provided on at least one of one and the other side in the length direction of the first recess. The second recess houses the first end portion partly. The case is provided with a housing hole on one side in the orthogonal direction of the first recess and in communication with the first recess so as to pass through the case. The housing hole houses the head of the cable tie.

### CROSS-REFERENCE TO RELATED APPLICATIONS

The present application claims priority under 35 U.S.C. §119 of Japanese Patent Application No. 2012-203194 filed on Sep. 14, 2012, the disclosure of which is expressly incorporated by reference herein in its entity.

### BACKGROUND OF THE INVENTION

1. Technical Field

The invention relates to connectors incorporating cable ties.

2. Background Art

As examples of conventional connectors of this type, Japanese Patent Application Laid-Open No. JP 2002-118936 A and Japanese Utility Model Application Laid-Open No. JP S56-62683 U disclose first and second connectors, respectively, as described below. The first and second connectors each include a cable, a cable tie, and a case.

The first connector is configured such that the strap of the cable tie is wound around a first end portion in the length direction of the cable and is engaged in an engaging hole in the head of the cable tie. The cable tie thus ties the first end portion of the cable. The case has a recess and a hole, and the hole is provided in the bottom of the recess to communicate between the recess and the outside of the case. The head of the cable tie fits in the recess of the case, and the portion of the strap that is drawn from the engaging hole in the head (drawn portion) is inserted into the hole in the case.

In the first connector, the strap of the cable tie is wound around the first end portion of the cable and is engaged into the engaging hole in the head, thereby temporarily fastening the cable tie around the first end portion of the cable. The temporarily fastened cable tie and first end portion of the cable are put into the case, and the drawn portion of the strap of the cable tie is inserted into the hole in the case to fit the head into the recess of the case. Thereafter, the drawn portion of the strap is pulled to further fasten the strap so that the cable tie ties the first end portion of the cable inside the case.

In the second connector, the case has a block and a recess. The strap of the cable tie is wound around a first end portion in a length direction of the cable and the block of the case, and the strap is engaged in an engaging hole in a head. The cable tie thus ties the first end portion of the cable and the block. The head of the cable tie fits into the recess of the case such that the portion of the strap that is drawn from the engaging hole of the head (drawn portion) is led out of the recess of the case to the outside of the case.

In the second connector, the cable tie is put into the case to fit the head of the cable tie into the recess of the case. Thereafter, the first end portion of the cable is put into the case, and the strap of the cable tie is wound around the first end portion of the cable and the block, and the strap is engaged into the engaging hole in the head. The cable tie thus ties the first end portion of the cable and the block.

### SUMMARY OF INVENTION

In the first connector, the head of the cable tie fits in the recess of the case, but the first end portion of the cable is not fixed in position inside the case. When the strap of the cable tie is pulled to tie the first end portion of the cable with the cable tie inside the case, the cable tends to move toward the head of the cable tie, placing strain on the junctions between the cable and the object to be connected.

On the other hand, in the second connector, it is possible to prevent the movement of the cable by bringing it into abutment with the block of the case when the strap of the cable tie is pulled to tie the first end portion of the cable inside the case. However, the strap of the cable tie is required to be wound around the first end portion of the cable and the block inside the case to engage the strap into the engaging hole of the head. The tying work of the cable is thus difficult.

The invention has been made in view of the above circumstances. The invention provides a connector making it possible to prevent a cable from moving during tying a first end portion of the cable with a cable tie inside a case and to thereby improve the operability of the tying work.

The invention of an aspect provides a connector including a cable, a connecting element, a cable tie, and first and second cases. The cable includes a first end portion in a length direction thereof. The connecting element is connected to the cable. The cable tie includes a head and a strap. The head has an engaging hole, and the strap is configured to tie the first end portion of the cable and be engaged in the engaging hole in the head. The first and second cases are combined with each other so as to house the first end portion of the cable, the connecting element, and the cable tie. The first case includes a first recess, a second recess, and a housing hole. The first recess extends in an orthogonal direction orthogonal to the length direction and houses the strap of the cable tie partly. The second recess is provided on at least one of one and the other side in the length direction of the first recess and partly houses the first end portion of the cable securely. The housing hole is provided on one side in the orthogonal direction of the first recess and in communication with the first recess so as to pass through the first case. The housing hole houses the head of the cable tie.

In the connector of this aspect, the first recess extends in the orthogonal direction; the housing hole is provided on one side in the orthogonal direction of the first recess; and the cable tie temporarily fastening the first end portion of the cable has its strap partly housed in the first recess and its head housed in the housing hole. Therefore, when the portion of the strap of the cable tie that is drawn from the engaging hole is pulled to tie the first end portion of the cable with the cable tie inside the first and second cases, the drawn portion of the strap of the cable tie is pulled to the one side in the orthogonal direction. On the other hand, the first end portion of the cable is securely housed in the second recess. In other words, the first end portion of the cable is held in position in the orthogonal direction inside the second recess. This arrangement can prevent the first end portion of the cable at the time of tying from moving in the orthogonal direction inside the first and second cases. It is therefore possible to avoid strain on the junctions between the cable and the connecting element and thereby facilitate the tying operation of the cable. In addition, the cable tie can be easily positioned with respect to the cable, simply by housing the first end portion of the cable in the second recess, housing the strap of the cable tie in the first recess, and housing the head of the cable tie in the housing hole. It is therefore possible to reduce variation in tying position of the cable tie with respect to the cable.

The first recess may have a dimension in the length direction that is slightly larger than a width dimension of the strap of the cable tie. The housing hole may have slightly larger dimensions than the outer dimensions of the head.

In the connector of this aspect, when pulling the portion of the strap of the cable tie that is drawn from the engaging hole, the strap is guided by the first recess and the head is held in position in the housing hole. This arrangement facilitates the tying operation of the cable tie. In addition, the cable tie has its strap held in position in the first recess and its head held in position in the housing hole, resulting in improved tension strength of the cable tied with the cable tie.

The second recess may have a dimension in the orthogonal direction that is slightly larger than the outside diameter of the first end portion of the cable and partly houses the first end portion of the cable securely.

The second recesses may include a plurality of second recesses provided on one and the other side in the length direction of the first recess. The first recess may be disposed between the second recesses. In the connector of this aspect, the first recess is provided between the second recesses. This can further improve the tension strength of the cable tied with the cable tie.

The second case may include a first recess and a second recess. The first recess may be configured to partially house the strap of the cable tie, the first recess having a dimension in the length direction that is slightly larger than a width dimension of the strap of the cable tie. The second recess may be provided on at least one of one and the other side in the length direction of the first recess of the second case. The second recess may have a dimension in the orthogonal direction that is slightly larger than the outside diameter of the first end portion of the cable to partially house the first end portion of the cable securely.

In the connector of this aspect, when pulling the portion of the strap of the cable tie drawn from the engaging hole, the strap is guided by the first recesses of the first and second cases, thereby facilitating the tying operation of the cable tie. In addition, the strap of the cable tie is held in position in the length direction inside the first recesses of the first and second cases, and the first end portion of the cable is held in position in the orthogonal direction inside the second recesses of the first and second cases. This can improve the tension strength of the cable tied with the cable tie.

The housing hole in the first case may have an outer opening that is open to the outer side of the first case. The strap of the cable tie may have a distal end face being a cut face. The end face may be exposed from the outer opening of the housing hole.

If the strap has a cut face facing a wall of the housing hole, it is difficult to cut the strap drawn from the outer opening of the housing hole. However, in the connector of this aspect of the invention, the strap has the cut face exposed from the outer opening of the housing hole. More particularly, the uncut strap is drawn from the outer opening of the housing hole, it is easy to cut the strap at a position near the head. In particular, the strap can be easily cut near the head by using a tying tool for tying the cable tie.

The cable may include an outer insulator and a plurality of signal lines disposed inside the outer insulator. The connecting element may include a plurality of connecting elements. The connecting elements may each include a two-forked tail to hold the each signal line between tines thereof so as to establish connection between the connecting elements and the signal lines.

The connector of this aspect can more securely maintain the junctions between the signal line of the cable and the connecting elements. The junctions, even if under strain, are less like to suffer from disconnections or other troubles.

### BRIEF DESCRIPTION OF DRAWINGS

FIG. 1A is a front, top, right side perspective view of a connector according to an embodiment of the invention.

FIG. 1B is a rear, bottom, right side perspective view of the connector.

FIG. 2A is a cross-sectional view of the connector, taken along line 2A-2A in FIG. 1A.

FIG. 2B is a cross-sectional view of the connector, taken along line 2B-2B in FIG. 1A.

FIG. 2C is a cross-sectional view of the connector, taken along line 2C-2C in FIG. 1A.

FIG. 3A is an exploded rear, top, left side perspective view of the connector.

FIG. 3B is an exploded front, bottom, left perspective view of the connector.

FIG. 4A is a front, top, right side perspective view of a cable, first to third bodies, contacts, locking elements, and a cable tie of the connector.

FIG. 4B is a rear, bottom, right side perspective view of the cable, first to third bodies, contacts, locking elements, and a cable tie of the connector.

FIG. 5A is an exploded front, top, right side perspective view of the cable, first to third bodies, contacts, locking elements, and a cable tie of the connector.

FIG. 5B is an exploded rear, bottom, right side perspective view of the cable, the first to third bodies, the contacts, the locking elements, and the cable tie of the connector.

FIG. 6A is a rear, top, left side perspective view of the cable, the second and third bodies, the contacts, the locking elements, and the cable tie of the connector, in a state before the second body is attached to the third body.

FIG. 6B is a front, bottom, left side perspective view of the cable, the second and third bodies, the contacts, the locking elements, and the cable tie of the connector, in a state before the second body is attached to the third body.

### DESCRIPTION OF EMBODIMENTS

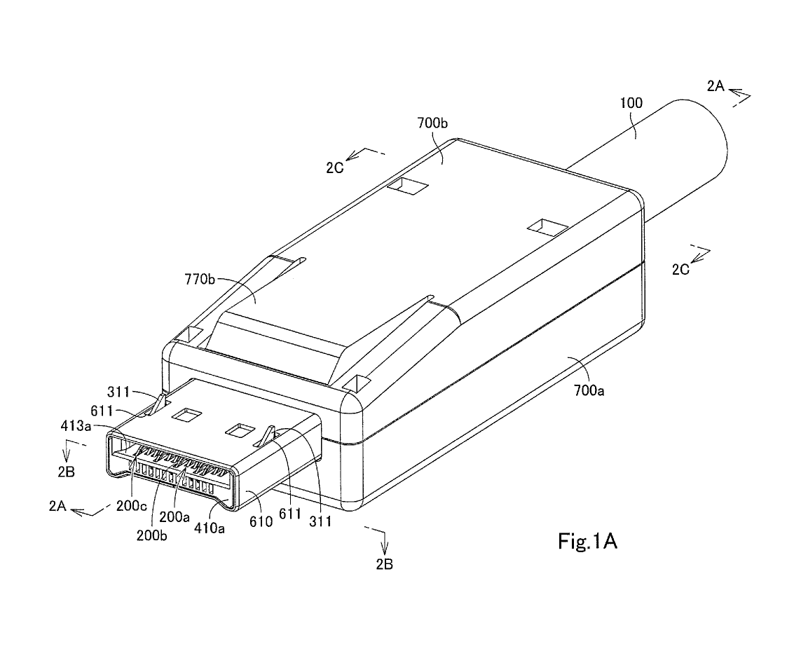

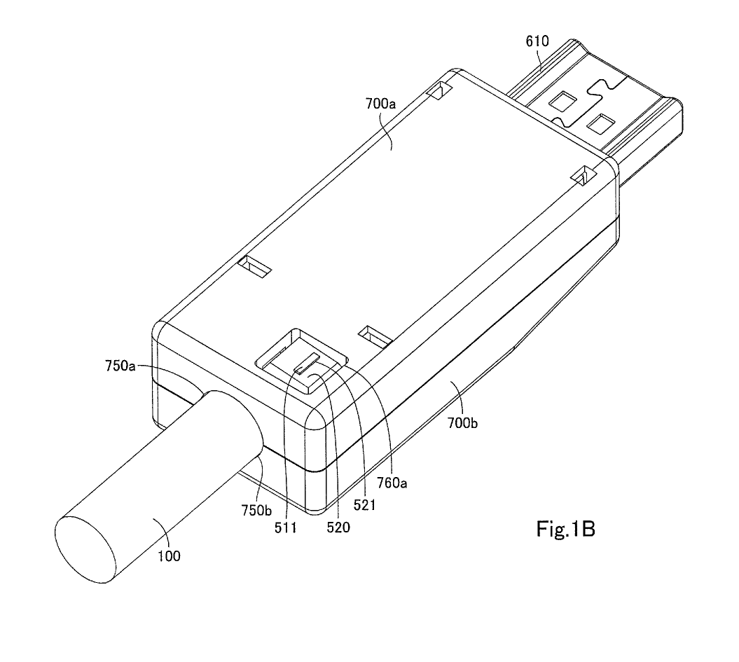

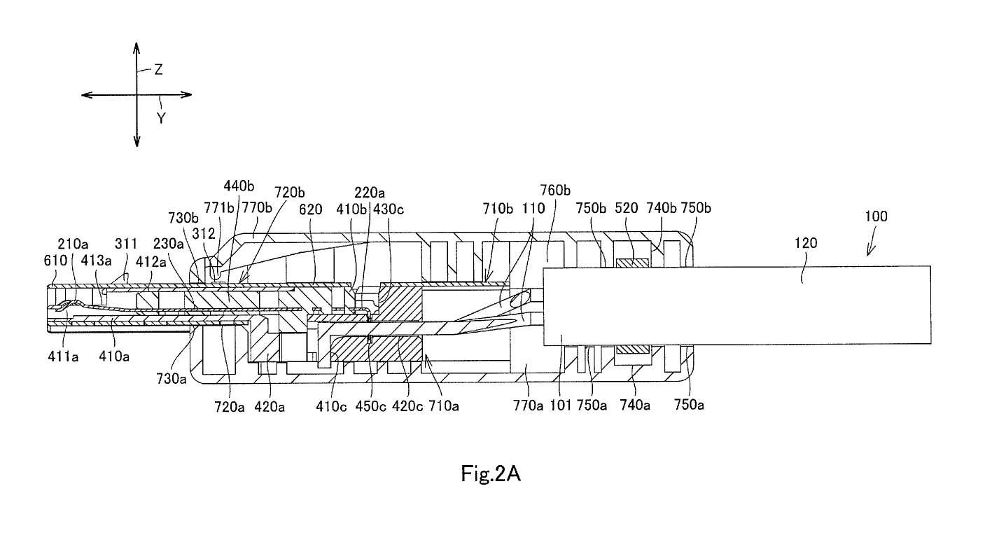

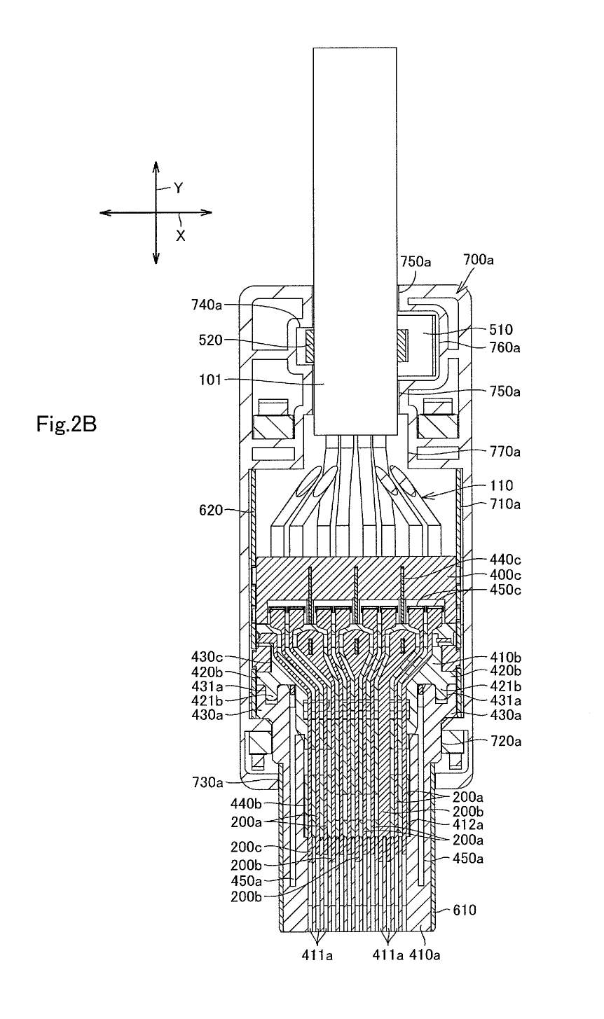

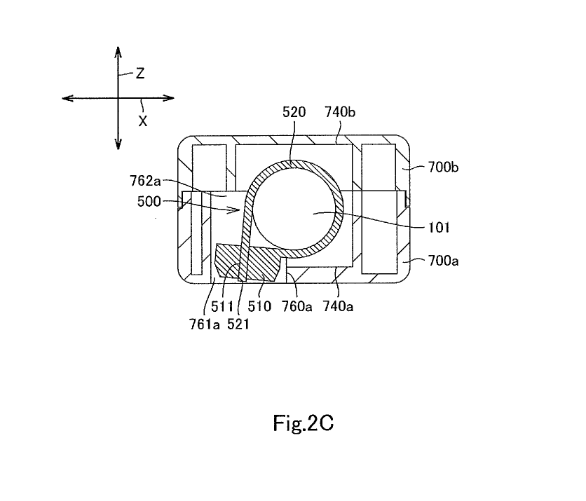

Hereinafter, a connector according to an embodiment of the invention will be described with reference to FIGS. 1A to 6B. The connector includes a cable 100, a plurality of contacts 200a (connecting element), a plurality of contacts 200b, a contact 200c, a pair of locking elements 300, a first body 400a, a second body 400b, a third body 400c, a cable tie 500, a shield cover 600, a first case 700a, and a second case 700b. These components of the connector will be described below in detail. FIGS. 2A, 2B, 3A, 3B, 5A, and 5B show the length direction Y of the connector and the cable 100. FIGS. 2B, 2C, 3A, 3B, 5A, and 5B show the direction X, which is the widthwise direction of the connector and also a direction orthogonal to the length direction of the cable 100 (hereinafter referred to as the “orthogonal direction”). FIGS. 2A, 2C, 3A, 3B, 5A, and 5B show the height direction Z of the connector. The X direction is orthogonal to the Y direction, and the Z direction is orthogonal to the X and Y directions.

As shown in FIGS. 2A to 2C, 3A, 3B, 5A, and 5B, the cable 100 has a plurality of signal lines 110, a shield conductor (not shown), and an outer insulator 120. Each of the signal lines 110 has a core and an insulator covering the core. The shield conductor is tuboid and covers all the signal lines 110. The outer insulator 120 is tuboid and covers the shield conductor. In other words, the signal lines 110 are disposed in the shield conductor and the outer insulator 120. The cable 100 includes a first end portion 101 in the length direction, in which lengthwise first end portions of the signal lines 110 project from the shield conductor and the outer insulator 120. It is noted that FIG. 2C does not illustrate the inner configuration of the first end portion 101 of the cable 100.

The cable tie 500 includes a head 510 and a strap 520 as shown in FIGS. 2A to 2C and 3A to 6B. The head 510 is provided with an engaging hole 511 passing therethrough. The base end of the head 510 is joined the strap 520. The strap 520 is wound around the first end portion 101 of the cable 100 and is engaged in the engaging hole 511. The cable tie 500 thus ties the signal lines 110 in the first end portion 101 of the cable 100. The strap 520 is partly drawn out of the engaging hole 511, and the drawn portion is cut off. That is, the distal end face of the strap 520 forms a cut face 521.

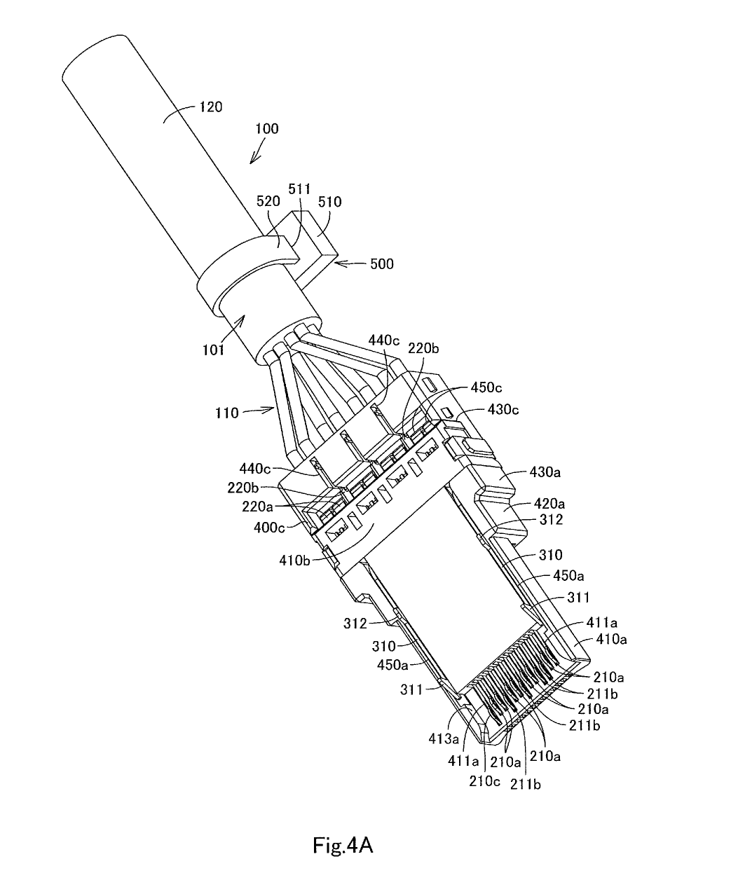

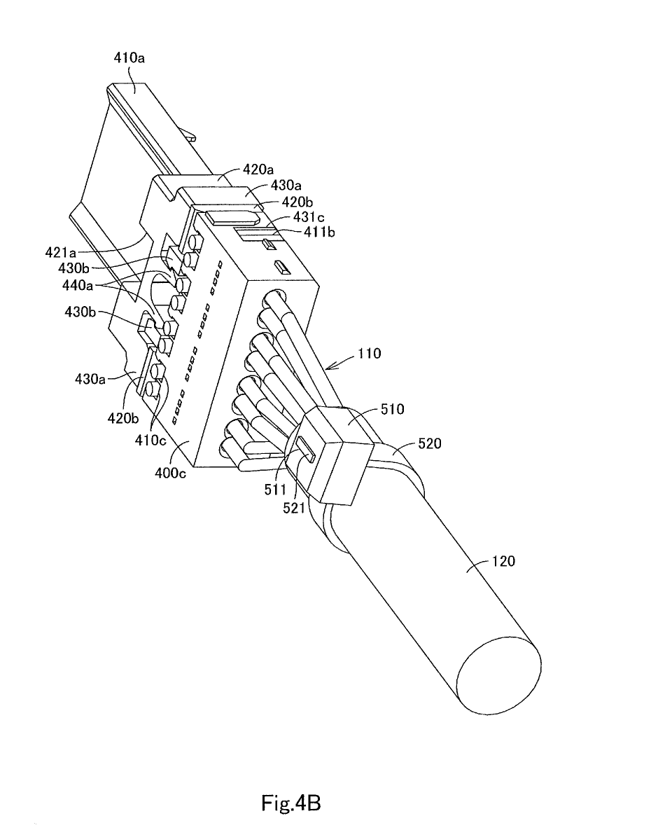

The third body 400c is a block made of an insulating resin as shown in FIGS. 4A to 6B. The lower portion of the front end (one end in the Y direction) of the third body 400c is provided with a plurality of positioning recesses 410c arranged in spaced relation along the X direction. In addition, the rear end face (the other end face in the Y direction) of the third body 400c is provided with a plurality of positioning holes 420c arranged in spaced relation along the X direction. The positioning holes 420c are open to the rear side (the other side in the Y direction) and extend in the Y direction to communicate with the positioning recesses 410c. The first end portions of the signal lines 110 of the cable 100 are inserted into the positioning recesses 410c and the positioning holes 420c to be held in position in spaced relation along the X direction.

An attaching recess 430c is provided in the upper front portion of the third body 400c. The edges in the X direction of the attaching recess 430c are each provided with an engaging recess 431c. The third body 400c is further provided with first slits 440c in spaced relation in the X direction. The first slits 440c extend in the Y direction, from the rear portion of the third body 400c to the bottom of the attaching recess 430c. The bottom of the attaching recess 430c is also provided with a plurality of pairs of second slits 450c, and the pairs are respectively arranged in each space between the first slit 440c at each end and the adjacent edge of the attaching recess 430c and in each space between the adjacent first slits 440c. In other words, each of these four pairs is provided in each of the above four spaces. The second slits 450c extend in the X direction and communicate with the respective positioning holes 420c.

The second body 400b is made of an insulating resin. As shown in FIGS. 4A to 6B, the second body 400b is embedded with the contacts 200a, 200a, 200b, 200a, 200a, 200b, 200a, 200a, 200b, 200a, 200a, and 200c that are arrayed in this order in spaced relation in the X direction. The second body 400b includes an attaching portion 410b, a pair of abutting plates 420b, a pair of locking pieces 430b, and a fitting portion 440b.

The attaching portion 410b is a generally rectangular block forming a rear portion (the other end in the Y direction) of the second body 400b. The attaching portion 410b fits in the attaching recess 430c. An engaging piece 411b is provided at each end in the X direction of the attaching portion 410b. The engaging pieces 411b are engaged in the associated engaging recesses 431c of the third body 400c.

The abutting plates 420b are generally rectangular plates provided in outer areas in the X direction of the front face of the attaching portion 410b to extend in the Z direction. A projection 421b is provided on the front face (one end face in the Y direction) of each of the abutting plates 420b. The fitting portion 440b projects from the front center of the attaching portion 410b. The pair of locking pieces 430b is disposed in spaced relation in the X direction on the lower center of the attaching portion 410b. The locking pieces 430b extend to the front side (one side in the Y direction).

The contacts 200a are generally L-shaped metal plates as shown in FIGS. 2A, 2B, and 4A to 6B. Each of the contacts 200a includes a contact portion 210a, a tail 220a, and an intermediate portion 230a. The intermediate portion 230a is a plate located between the contact portion 210a and the tail 220a and embedded in the second body 400b. The front portion (one end portion in the Y direction) of the intermediate portion 230a projects from the front face (one end face in the Y direction) of the second body 400b to the front side (one side in the Y direction). The rear end (the other end in the Y direction) of the intermediate portion 230a projects from the rear face (the other end face in the Y direction) of the attaching portion 410b of the second body 400b. The contact portion 210a is a plate contiguous with the front end of the intermediate portion 230a, and it is curved upward in arc shape. The tail 220a is contiguous with the rear end of the intermediate portion 230a and bent at right angle to the intermediate portion 230a. The tail 220a is two-forked. The tails 220a are inserted in the associated second slits 450c in the third body 400c, in which state the tails 220a each hold between their tines the first end portion of each signal line 110 of the cable 100. Specifically, the tails 220a pierce through the insulators of the first end portions of the signal line 110 and securely hold the cores of the signal lines 110. The contacts 200a are thus electrically connected to the signal lines 110.

The contacts 200b are configured as shown in FIGS. 2B and 4A to 6B. The contacts 200b each include a contact body 210b and a shielding plate 220b. The contact body 210b is a metal plate including a contact portion 211b, a tail 212b, and an intermediate portion 213b. The intermediate portion 213b is a plate located between the contact portion 211b and the tail 212b and embedded in the second body 400b. The front portion (one end portion in the Y direction) of the intermediate portion 213b projects from the front face (one end face in the Y direction) of the second body 400b to the front side (the one side in the Y direction). The contact portion 211b is a plate contiguous with the front end of the intermediate portion 213b, and it is curved upward in arc shape. The tail 212b is a plate contiguous with the rear end of the intermediate portion 230a. The shielding plate 220b is a metal plate attached to the tail 212b of the contact body 210b. The tail 212b and the front portion (one end portion in the Y direction) of the shielding plate 220b are embedded in the attaching portion 410b of the second body 400b. In other words, the portion of the shielding plate 220b other than the front portion (hereinafter referred to as a projecting portion) projects between the adjacent tails 220a of the contacts 200a from the rear face of the attaching portion 410b to the rear side (the other side in the Y direction). The projecting portions of the shielding plates 220b are inserted in the associated first slits 440c in the third body 400c.

The contact 200c is a metal plate as shown in FIGS. 2B and 4A to 6B. The contact 200c includes a contact portion 210c, a tail 220c, and an intermediate portion 230c. The intermediate portion 230c is a plate located between the contact portion 210c and the tail 220c and embedded in the second body 400b. The front portion (one end portion in the Y direction) of the intermediate portion 230c projects from the front face (one end face in the Y direction) of the second body 400b to the front side (the one side in the Y direction). The contact portion 210c is a plate contiguous with the front end of the intermediate portion 230c, and it is curved upward in arc shape. The tail 220c is a plate contiguous with the rear end of the intermediate portion 230c and embedded in the attaching portion 410b of the second body 400b.

The first body 400a is made of an insulating resin. As shown in FIGS. 4A to 6B, the first body 400a includes a plate 410a, a block 420a, a pair of flanges 430a, a pair of locking pieces 440a, and a pair of slits 450a. The plate 410a is a generally rectangular plate. The upper front portion (one end in the Y direction) of the plate 410a is recessed (a recess 413a). The front portion of the plate 410a is formed with a plurality of housing grooves 411a in spaced relation in the X direction. The housing grooves 411a communicate with the recess 413a. The plate 410a also has a rectangular fitting hole 412a on the rear side (the other end in the Y direction) of the housing grooves 411a. The fitting hole 412a communicate with the housing grooves 411a. The contact portions 210a, 211b, and 210c of the contacts 200a, 200b, and 200c are inserted from the fitting hole 412a into the housing grooves 411a and exposed upward from the housing grooves 411a. The fitting hole 412a fittingly receives the fitting portion 440b of the second body 400b.

The block 420a is generally U-shaped part integrally provided around the rear portion (the other end portion in the Y direction) of the plate 410a. In other words, the rear portion of the plate 410a is integrally disposed between upper end portions (in the one end in the Z direction) of the block 420a. The block 420a has a rectangular recess 421a at its lower end (the other end in the Z direction). The flanges 430a are provided on outer areas in the X direction of the rear face (the other end face in the Y direction) of the block 420a. The flanges 430a are rectangular blocks extending further outside than the end faces in the X direction of the block 420a. The rear faces (the other end faces in the Y direction) of the flanges 430a are each provided with a hole 431a. The holes 431a fittingly receive the projections 421b of the abutting plates 420b of the second body 400b such that the abutting plates 420b abut the flanges 430a. The locking pieces 440a are provided in the central area of the rear face of the block 420a. The locking pieces 440a extend to the rear side (the other side in the Y direction) to be locked against the locking pieces 430b of the second body 400b.

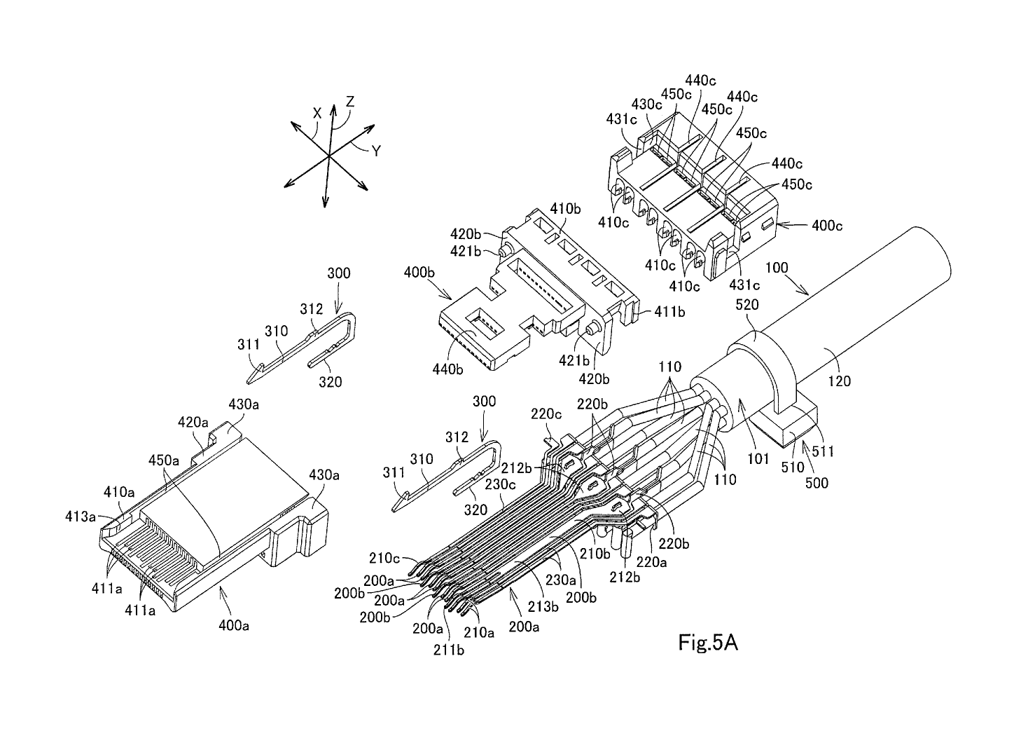

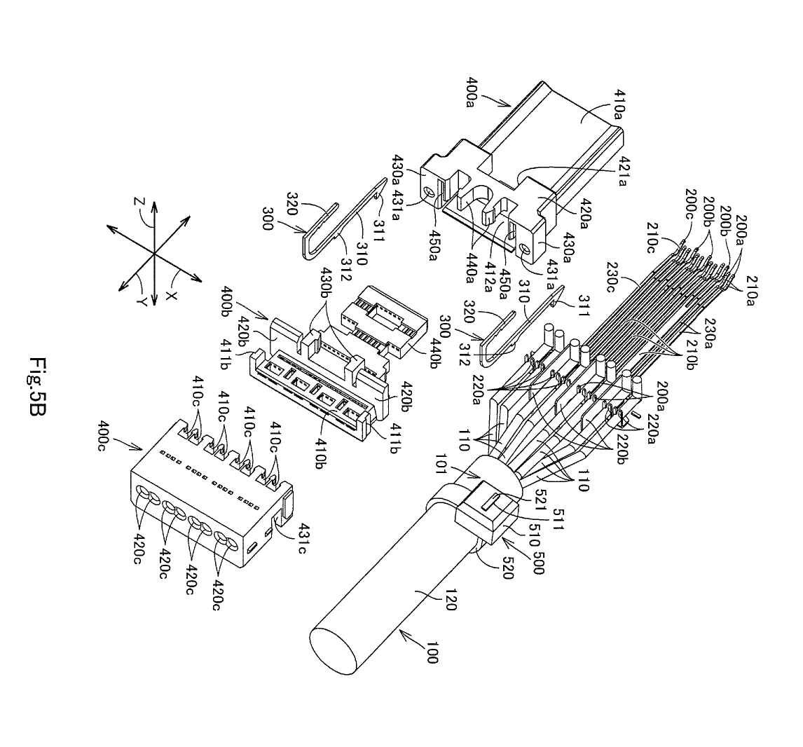

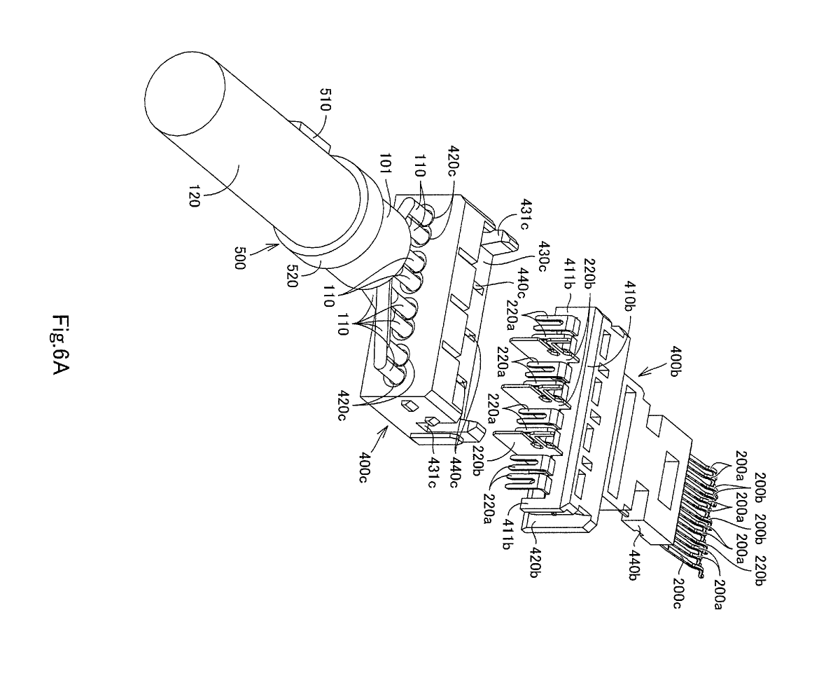

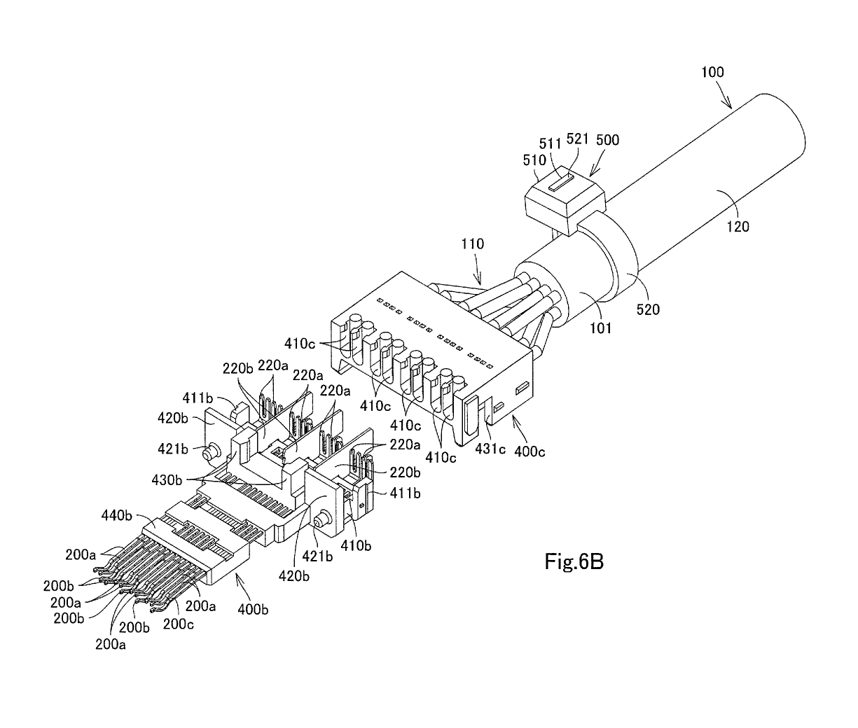

The pair of slits 450a extends along end portions in the X direction of the plate 410a and the block 420a. As shown in FIGS. 5A to 6A, the locking elements 300 are generally U-shaped metal plates and fixedly inserted in the slits 450a. Each of the locking elements 300 has a first arm 310 and a second arm 320. The first arm 310 is longer than the second arm 320. The distal end of the first arm 310 is provided with a pawl 311. The proximal portion of the first arm 310 is provided with a convex portion 312. The pawl 311 and the convex portion 312 project upward from the slit 450a.

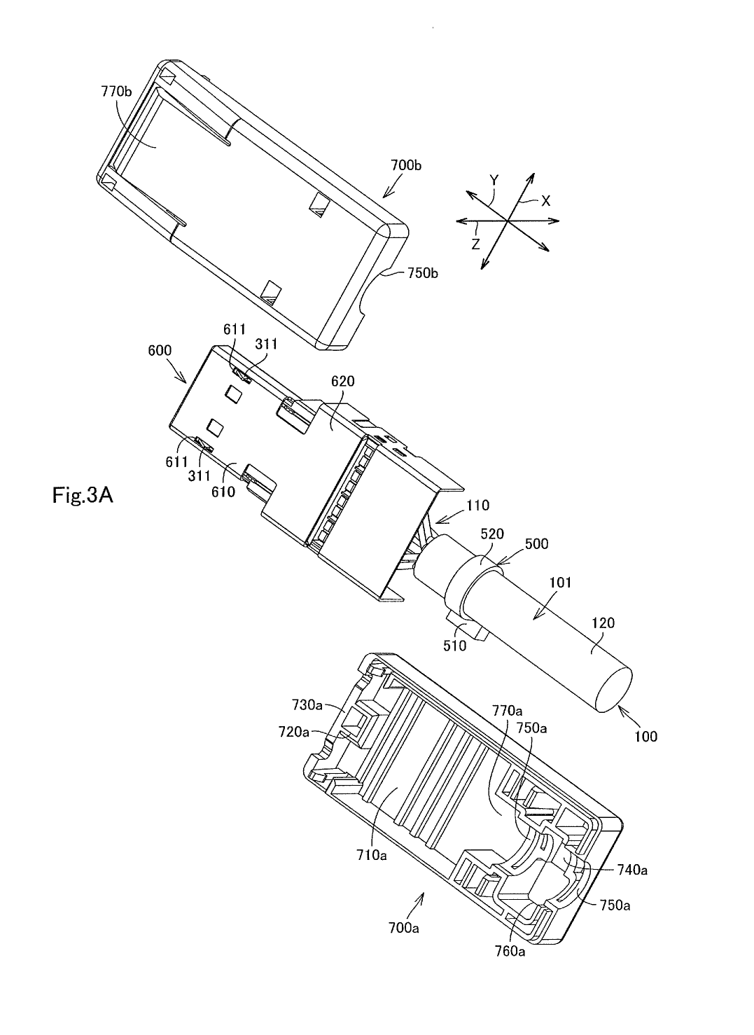

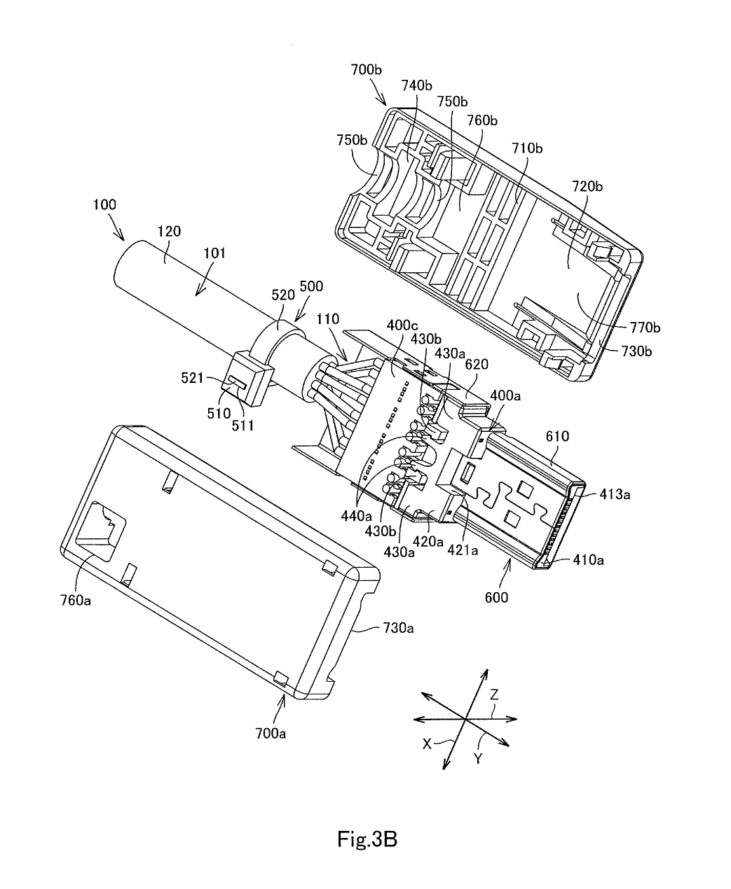

The shield cover 600 is formed of a metal plate. As shown in FIGS. 2A, 2B, 3A, and 3B, the shield cover 600 includes a tube 610 and a cover 620. The tube 610 has a generally square tuboid inner shape conforming to the outer shape of the plate 410a of the first body 400a. Accordingly, the tube 610 fittingly receive the plate 410a. The tube 610 has a pair of openings 611 to allow the paws 311 of the locking elements 300 to project upward. The cover 620 is a generally U-shaped plate contiguously provided with the tube 610 to cover the flanges 430a and the locking pieces 440a of the first body 400a, the second body 400b, and the third body 400c, and the first end portions of the signal lines 110.

The first case 700a and the second case 700b are insulating resin cases assembled together. As shown in FIGS. 2A to 3B, the first case 700a includes a housing recess 710a, a housing portion 720a, an opening 730a, a first recess 740a, two second recesses 750a, a housing hole 760a, and a third recess 770a. As shown in FIGS. 2A to 3B, the second case 700b has a first housing portion 710b, a second housing portion 720b, an opening 730b, a first recess 740b, two second recesses 750b, a third recess 760b, and a button 770b.

The housing recess 710a is provided in the center of the first case 700a. The first housing portion 710b is provided in the center of the second case 700b. The housing recess 710a and the first housing portion 710b communicate with each other to define a first housing space. The first housing space houses the cover 620 of the shield cover 600, the flanges 430a and the locking pieces 440a of the first body 400a, the second body 400b, the third body 400c, the rear portions of the contacts 200a, 200b, and 200c, and the first end portions of the signal lines 110.

The housing portion 720a of the first case 700a is a space provided on the front side (the one side in the Y direction) of the housing recess 710a and in communication with the housing recess 710a. The opening 730a is provided on the front side (the one side in the Y direction) of the housing portion 720a of the first case 700a. The opening 730a is open at its front (the one side in the Y direction) to the outside of the first case 700a and communicates at its rear with the housing portion 720a. The second housing portion 720b of the second case 700b is a space provided on the front side (the one side in the Y direction) of the first housing portion 710b and in communication with the first housing portion 710b. The opening 730b is open at its front (the one side in the Y direction) to the outside of the second case 700b and communicates at its rear with the housing portion 720b. The housing portion 720a, the second housing portion 720b, and the openings 730a and 730b communicate with each other to define a second housing space. The second housing space houses the rear portion of the tube 610 of the shield cover 600, the rear portion of the plate 410a of the first body 400a, and the intermediate portions of the contacts 200a, 200b, and 200c. The tube 610 of the shield cover 600 excluding the rear portion, the plate 410a of the first body 400a excluding the rear portion, and the distal ends of the contacts 200a, 200b, and 200c project from the openings 730a and 730b to the outside of the first case 700a and the second case 700b.

The third recess 770a is provided on the rear side (the other side in the Y direction) of the housing recess 710a of the first case 700a and in communication with the housing recess 710a. The third recess 760b is provided on the rear side (the other side in the Y direction) of the first housing portion 710b of the second case 700b and in communication with the first housing portion 710b. The third recesses 770a and 760b communicate with each other to define a cable housing space. The cable housing space partially houses the first end portion 101 of the cables 100.

The first recess 740a is provided on the rear side (the other side in the Y direction) of the third recess 770a of the first case 700a. The first recess 740b is provided on the rear side (the other side in the Y direction) of the third recess 760b of the second case 700b. The first recesses 740a and 740b extend in the X direction (the orthogonal direction). The first recesses 740a and 740b each have a dimension in the Y direction that is slightly larger than the width dimension of the strap 520 of the cable tie 500. The strap 520 of the cable tie 500 is received in the first recesses 740a and 740b securely in position in the Y direction.

One of the second recesses 750a is provided on the one side in the Y direction of the first recess 740a of the first case 700a and in communication with the first recess 740a and the third recess 770a. The other second recess 750a is provided on the other side in the Y direction of the first recess 740a of the first case 700a and in communication with the first recess 740a. The other second recess 750a is open at its rear (the other side in the Y direction) to the outside of the first case 700a. One of the second recesses 750b is provided on the one side in the Y direction of the first recess 740b of the second case 700b and in communication with the first recess 740b and the third recess 760b. The other second recess 750b is provided on the other side in the Y direction of the first recess 740b of the second case 700b and in communication with the first recess 740b. The other second recess 750b is open at its rear (the other side in the Y direction) to the outside of the second case 700b. The second recesses 750a and 750b are arc-shaped recesses. The second recesses 750a and 750b each have a dimension in the X direction that is slightly larger than the outside diameter of the cable 100. The first end portion 101 of the cable 100 is partially housed in the second recesses 750a and 750b to be held in position in a radius direction (the direction including the X and Z directions) of the cable 100.

The housing hole 760a is provided on the one side in the X direction (the orthogonal direction) of the first recess 740a of the first case 700a and in communication with the first recess 740a. The housing hole 760a is a through-hole passing in the Z direction from an inner side to an outer side of the first case 700a. More particularly, the housing hole 760a includes an inner opening 762a opening to the inner side and an outer opening 761a opening to the outer side. The housing hole 760a has slightly larger dimensions than the outer dimensions of the head 510 of the cable tie 500. The housing hole 760a houses the head 510 of the cable tie 500 securely in position in the X and Y directions. The head 510 as housed is oriented such that its engaging hole 511 extends in its length direction generally along the extending direction of the housing hole 760a, and that the cut face 521 of the strap 520 is exposed from the outer opening 761a of the housing hole 760a. The cut face 521 is located near the head 510. As shown in FIG. 2C, the head 510 and the cut face 521 do not project from the housing hole 760a to the outside of the first case 700a.

The button 770b is provided at the bottoms of the first housing portion 710b and the second housing portion 720b. As shown in FIG. 2A, the distal end of the button 770b is provided with a convex depressing portion 771b, which is located above the convex portions 312 of the first arms 310 of the locking elements 300. When the button 770b is depressed, the depressing portion 771b depresses the convex portions 312 of the first arms 310. The pawls 311 of the first arm 310 accordingly move downward.

The connector as described above may be manufactured in the following steps. The first step is to prepare the contacts 200a, the contacts 200b, and the contact 200c. The shielding plates 220b of the contacts 200b are fixed to the tails 212b of the contact bodies 210b in advance. The contacts are arrayed in spaced relation in the X direction in a die (not shown) in the order of 200a, 200a, 200b, 200a, 200a, 200b, 200a, 200a, 200b, 200a, 200a, and 200c. An insulating resin is injected into the die to insert-mold the intermediate portions 230a of the contacts 200a, the intermediate portions 213b and the tails 212b of the contact bodies 210b and the front portions of the shielding plates 220b of the contacts 200b, and the intermediate portion 230c and the tail 220c of the contact 200c in the insulating resin. The insulating resin hardens to form the second body 400b. The contacts are thus embedded in the second body 400b in the array order indicated above.

Also prepared are the cable 100 and the third body 400c. In the cable 100, the outer insulator 120 and the shield conductor of the first end portion 101 are cut off in advance to make the signal lines 110 stick out. The signal lines 110 are respectively inserted into the positioning holes 420c and the positioning recesses 410c in the third body 400c. The signal lines 110 are thus securely positioned in spaced relation along the X direction in the third body 400c.

The next step is to fit the attaching portion 410b of the second body 400b into the attaching recess 430c of the third body 400c. At this point, the engaging pieces 411b of the attaching portion 410b engage with the associated engaging recesses 431c of the third body 400c. Also, the tails 220a of the contacts 200a are inserted into the respective second slits 450c in the third body 400c, so that the tails 220a pierce through the insulators of the signal lines 110 to hold the cores of the signal lines 110. The contacts 200a are thus electrically connected to the signal lines 110 of the cable 100. Also, the projecting portions of the shielding plates 220b of the contacts 200b are inserted into the associated first slits 440c in the third body 400c. The shielding plates 220b are thus disposed each between one and the other pairs of adjacent tails 220a of the contacts 200a connected to the signal lines 110 as shown in FIGS. 2B, 5A, and 5B.

Also prepared are the first body 400a and the locking elements 300. The locking elements 300 are fixed into the slits 450a in the first body 400a, so that the pawls 311 and the convex portions 312 of the locking elements 300 project upward from the slits 450a.

Thereafter, the contact portions 210a, 211b, and 210c of the contacts 200a, 200b, and 200c are inserted from the fitting hole 412a of the first body 400a into the associated housing grooves 411a. Also, the fitting portion 440b of the second body 400b fits into the fitting hole 412a of the first body 400a. The projections 421b of the abutting plates 420b of the second body 400b fit into the holes 431a of the flanges 430a, so that the abutting plates 420b abut the flanges 430a. Also, the locking pieces 440a of the first body 400a are locked against the locking pieces 430b of the second body 400b.

The shield cover 600 is prepared. The plate 410a of the first body 400a is inserted into the tube 610 of the shield cover 600. The cover 620 of the shield cover 600 covers the flanges 430a and the locking pieces 440a of the first body 400a, the second body 400b, the third body 400c, and the first end portions of the signal lines 110.

A cable tie is prepared. The cable tie at this point is different from the cable tie 500 only in that the strap is not cut. The strap of the cable tie is wound around the first end portion 101 of the cable 100, and the strap is inserted into the engaging hole in the head of the cable tie. The strap of the cable tie thus temporarily holds the first end portion 101 of the cable 100.

The first case 700a is prepared. Into the housing recess 710a of the first case 700a are inserted the cover 620 of the shield cover 600, the flanges 430a and the locking pieces 440a of the first body 400a, the second body 400b, the third body 400c, the rear portions of the contacts 200a, 200b, and 200c, and the first end portions of the signal lines 110. Also, into the housing portion 720a and the opening 730a of the first case 700a are inserted the rear portion of the tube 610 of the shield cover 600, the rear portion of the plate 410a of the first body 400a, and the intermediate portions of the contacts 200a, 200b, and 200c. From the opening 730a project the tube 610 excluding its rear portion of the shield cover 600, the plate 410a excluding its rear portion of the first body 400a, and the distal portions of the contacts 200a, 200b, and 200c.

At this point, the portion of the strap of the cable tie that is drawn from the engaging hole (hereinafter referred to as a drawn portion) is inserted into the housing hole 760a of the first case 700a to place the head of the cable tie in the housing hole 760a. The head is thus held in position in the housing hole 760a, with the drawn portion of the strap projecting from the housing hole 760a to the outside of the first case 700a. Also, the strap of the cable tie is partially inserted into the first recess 740a of the first case 700a, while the first end portion 101 of the cable 100 is partially inserted into the second recesses 750a and the third recess 770a of the first case 700a. As a result, the strap is securely positioned in the Y direction in the first recess 740a, while the first end portion 101 of the cable 100 is held in X-direction position in the second recesses 750a.

The second case 700b is prepared. The second case 700b is assembled to the first case 700a. More particularly, the first housing portion 710b of the second case 700b receive the cover 620 of the shield cover 600, the flanges 430a and the locking pieces 440a of the first body 400a, the second body 400b, the third body 400c, the rear portions of the contacts 200a, 200b, and 200c, and the first end portions of the signal lines 110; the second housing portion 720b and the opening 730b of the second case 700b receive the rear portion of the tube 610 of the shield cover 600, the rear portion of the plate 410a of the first body 400a, and the intermediate portions of the contacts 200a, 200b, and 200c; from the opening 730b project the tube 610 excluding its rear portion of the shield cover 600, the plate 410a excluding its rear portion of the first body 400a, and the distal portions of the contacts 200a, 200b, and 200c; the first recess 740b of the second case 700b receives the strap of the cable tie partially, while the second recesses 750b and the third recess 760b of the second case 700b partly receives the first end portion 101 of the cable 100. The assembly of the second case 700b to the first case 700a is also conductive to the holding of the strap in position in the Y direction in the first recess 740b and the first end portion 101 of the cable 100 in the X direction in the second recesses 750b.

Lastly, the drawn portion of the strap of the cable tie is further fastened by pulling it with a cable tying tool (e.g., TYMATE (registered trademark) manufactured by HellermannTyton) and cutting the drawn portion. At this time, the first recesses 740a and 740b restrict movement of the strap in the Y direction but allow movement to one side in the X direction (that is, they guide the strap in the X direction). The cable tie with the drawn portion of the strap cut off becomes the cable tie 500. The cut face of the strap 520 of the cable tie 500 becomes the cut face 521. The cable tie 500 thus ties the signal lines 110 of the first end portion 101 of the cable 100 inside the first case 700a and the second case 700b. The drawn portion of the strap of the cable tie may be cut off without using a tying tool. For example, an operator may pull the drawn portion to the one side in the X direction to tie the signal lines 110 in the first end portion 101 of the cable 100 with the cable tie, and then cut off the drawn portion with scissors or other tool.

The above described connector has at least the following technical features and advantages. Firstly, the cable tie 500 is guided during the tying by the first recesses 740a and 740b of the first case 700a and the second case 700b, and it is pulled in the X direction. On the other hand, the first end portion 101 of the cable 100 is held in position in radius direction (including the X direction) inside the second recesses 750a and 750b of the first case 700a and the second case 700b. This arrangement can prevent the first end portion 101 of the cable 100 from moving in the X direction in the first case 700a and the second case 700b when tying the first end portion 101 with the cable tie 500 inside the first and second cases 700a, 700b. It is therefore possible to avoid strain on the junctions between the signal lines 110 of the cable 100 and the contacts 200a and also possible to ease the tying work of the cable tie.

Secondly, each signal line 110 of the cable 100 is held between the tines of the two-forked tail 220a of each contact 200a. This can more securely maintain the junctions between the signal lines 110 of the cable 100 and the contacts 200a. The junctions, even if under strain, are less like to suffer from disconnections or other troubles.

Thirdly, the cut face 521 of the strap 520 is exposed from the outer opening 761a of the housing hole 760a. That is, the uncut strap is drawn out of the outer opening 761a through the housing hole 760a, so that the strap can be easily cut at a position near the head 510. In particular, the strap can be easily cut near the head with a tying tool for tying the cable tie 500.

Fourthly, the first recess 740a and the housing hole 760a are provided between the second recesses 750a. The first recess 740a regulates the Y-direction position of the strap 520 of the cable tie 500, while the housing hole 760a regulates the X and Y-direction position of the head 510 of the cable tie 500. The second recesses 750a and 750b regulates the radius direction position of the first end portion 101 of the cable 100. This arrangement can improve tension strength of the cable 100.

Fifthly, the cable tie 500 can be easily positioned with respect to the cable 100, simply by placing the first end portion 101 of the cable 100 in the second recesses 750a and 750b, the strap 520 of the cable tie 500 in the first recesses 740a and 740b, and the head 510 of the cable tie 500 in the housing hole 760a. It is therefore possible to reduce variation in tying position of the cable tie 500 with respect to the cable 100.

The connector of the invention is not limited to the above embodiment but can be modified in any manner within the scope of the claims. Specific modifications will be described in detail below.

The first case 700a of the above embodiment has the housing recess 710a, the housing portion 720a, the opening 730a, the first recess 740a, the two second recesses 750a, the housing hole 760a, and the third recess 770a. However, the first case of the invention may have any configuration adapted to be assembled to the second case, house the first end portion of the cable, a connecting element (to be described), and the cable tie, and have first and second recesses and a housing hole as described below.

The first recess 740a of the above embodiment has a dimension in the Y direction that is slightly larger than the width dimension of the strap 520 of the cable tie 500. The first recess may have any configuration adapted to receive the strap of the cable tie partially.

The second recesses 750a of the above embodiment are provided on one and the other side in the Y direction of the first recess 740a. However, at least one second recess 750a will suffice if provided on at least one of one and the other side in the Y direction of the first recess 740a.

The housing hole 760a of the above embodiment is a through-hole provided on the one side in the X direction of the first recess 740a of the first case 700a to pass through the first case 700a, and it has slightly larger dimensions than the outer dimensions of the head 510 of the cable tie 500. However, the housing hole may be any hole provided on one side in a direction orthogonal to the length direction of the first recess and in communication with the first recess, passing through the first case to house the head of the cable tie.

The second case 700b of the above embodiment has the first recess 740b and the second recesses 750b. However, the second case may have any configuration adapted to be assembled to the first case and house the first end of the cable, the connecting element (to be described), and the cable tie. It is therefore possible to omit the first recess 740b, the second recesses 750b, and the third recess 760, and/or the button 770b.

The cable 100 of the above embodiment includes a plurality of signal lines 110. However, the cable of the invention is not limited to this. The cable may be a composite cable having different types of signal lines. The cable may also be a cable having a single signal line.

The connecting element as defined in the claims may be a contact 200a of the above embodiment connectable to a signal line 110. The connecting element may be any element connectable to a cable. For instance, the connecting element may be a circuit board or may be a conductive line formed on a body, and the circuit board or conductive line may be connected to a cable or to a signal line of a cable. In this case, the circuit board or conductive line may also be connected to a contact. Also, the contacts 200a of the above embodiment each include a two-forked tail 220a with its tines holding therebetween a signal line 110. However, the tail of each contact may be connected to the cable or a signal line of the cable by soldering. In other words, the tail may or may not be two-forked.

The connector of the above embodiment includes the first body 400a, the second body 400b, and the third body 400c. However, the connector of the invention only requires at least one body to hold a connecting element such as a contact.

The shield cover 600 and/or the engaging sections 300 can be omitted.

It should be appreciated that the above-described embodiment and modifications are described by way of examples only. The materials, shapes, dimensions, numbers, arrangements, and other configurations of the connector may be modified as long as they provide similar functions.

### REFERENCE SIGNS LIST

100: Cable
   101: First end
   110: Signal line
   120: Outer insulator
200a: Contact (connecting element)
   210a: Contact portion
   220a: Tail
   230a: Intermediate portion
200b: Contact
   210b: Contact body
      211b: Contact portion
      212b: Tail
      213b: Intermediate portion
   220b: Shielding plate
200c: Contact
   210c: Contact portion
   220c: Tail
   230c: Intermediate portion
300: Locking element
400a: First body
400b: Second body
400c: Third body
500: Cable tie
   510: Head
   511: Engaging hole
600: Shield cover
700a: First case
   710a: Housing recess
   720a: Housing portion
   730a: Opening
   740a: First recess
   750a: Second recess
   760a: Housing hole
   770a: Third recess
700b: Second case
   710b: First housing portion
   720b: Second housing portion
   730b: Opening
   740b: First recess
   750b: Second recess
   760b: Third recess
   770b: Button

1. A connector comprising:
a cable including a first end portion in a length direction thereof;
a connecting element connected to the cable;
a cable tie including a head and a strap, the head having an engaging hole, the strap being configured to tie the first end portion of the cable and be engaged in the engaging hole in the head; and
first and second cases combined with each other so as to house the first end portion of the cable, the connecting element, and the cable tie, the first case including:
a first recess extending in an orthogonal direction orthogonal to the length direction and housing the strap of the cable tie partly;
a second recess being provided on at least one of one and the other side in the length direction of the first recess and partly housing the first end portion of the cable securely; and
a housing hole provided on one side in the orthogonal direction of the first recess and in communication with the first recess so as to pass through the first case, the housing hole housing the head of the cable tie.

2. The connector according to claim 1, wherein the first recess has a dimension in the length direction that is slightly larger than a width dimension of the strap of the cable tie, and
the housing hole has slightly larger dimensions than the outer dimensions of the head.

3. The connector according to claim 1, wherein the second recess has a dimension in the orthogonal direction that is slightly larger than an outside diameter of the first end portion of the cable.

4. The connector according to claim 2, wherein
the second recess comprises a plurality of second recesses provided on one and the other side in the length direction of the first recess, and
the first recess is disposed between the second recesses.

5. The connector according to claim 1, wherein
the second case includes:
a first recess configured to partially house the strap of the cable tie, the first recess having a dimension in the length direction that is slightly larger than a width dimension of the strap of the cable tie; and
a second recess provided on at least one of one and the other side in the length direction of the first recess of the second case, the second recess having a dimension in the orthogonal direction that is slightly larger than the outside diameter of the first end portion of the cable to partially house the first end portion of the cable securely.

6. The connector according to claim 2, wherein
the second case includes:
a first recess configured to partially house the strap of the cable tie, the first recess having a dimension in the length direction that is slightly larger than a width dimension of the strap of the cable tie; and
a second recess provided on at least one of one and the other side in the length direction of the first recess of the second case, the second recess having a dimension in the orthogonal direction that is slightly larger than the outside diameter of the first end portion of the cable to partially house the first end portion of the cable securely.

7. The connector according to claim 4, wherein
the second case includes:
a first recess configured to partially house the strap of the cable tie, the first recess having a dimension in the length direction that is slightly larger than a width dimension of the strap of the cable tie; and
a second recess provided on at least one of one and the other side in the length direction of the first recess of the second case, the second recess having a dimension in the orthogonal direction that is slightly larger than the outside diameter of the first end portion of the cable to partially house the first end portion of the cable securely.

8. The connector according to claim 1, wherein
the housing hole in the first case has an outer opening that is open to the outer side of the first case, and
the strap of the cable tie has a distal end face being a cut face, the end face being exposed from the outer opening of the housing hole.

9. The connector according to claim 2, wherein
the housing hole in the first case has an outer opening that is open to the outer side of the first case, and
the strap of the cable tie has a distal end face being a cut face, the end face being exposed from the outer opening of the housing hole.

10. The connector according to claim 4, wherein
the housing hole in the first case has an outer opening that is open to the outer side of the first case, and
the strap of the cable tie has a distal end face being a cut face, the end face being exposed from the outer opening of the housing hole.

11. The connector according to claim 5, wherein
the housing hole in the first case has an outer opening that is open to the outer side of the first case, and
the strap of the cable tie has a distal end face being a cut face, the end face being exposed from the outer opening of the housing hole.

12. The connector according to claim 6, wherein
the housing hole in the first case has an outer opening that is open to the outer side of the first case, and
the strap of the cable tie has a distal end face being a cut face, the end face being exposed from the outer opening of the housing hole.

13. The connector according to claim 7, wherein
the housing hole in the first case has an outer opening that is open to the outer side of the first case, and
the strap of the cable tie has a distal end face being a cut face, the end face being exposed from the outer opening of the housing hole.

14. The connector according to claim 1, wherein
the cable includes an outer insulator and a plurality of signal lines disposed inside the outer insulator, and
the connecting element comprises a plurality of connecting elements, the connecting elements each including a two-forked tail to hold the each signal line between tines thereof so as to establish connection between the connecting elements and the signal lines.

15. The connector according to claim 2, wherein
the cable includes an outer insulator and a plurality of signal lines disposed inside the outer insulator, and
the connecting element comprises a plurality of connecting elements, the connecting elements each including a two-forked tail to hold the each signal line between tines thereof so as to establish connection between the connecting elements and the signal lines.

16. The connector according to claim 4, wherein
the cable includes an outer insulator and a plurality of signal lines disposed inside the outer insulator, and
the connecting element comprises a plurality of connecting elements, the connecting elements each including a two-forked tail to hold the each signal line between tines thereof so as to establish connection between the connecting elements and the signal lines.

17. The connector according to claim 5, wherein
the cable includes an outer insulator and a plurality of signal lines disposed inside the outer insulator, and
the connecting element comprises a plurality of connecting elements, the connecting elements each including a two-forked tail to hold the each signal line between tines thereof so as to establish connection between the connecting elements and the signal lines.

18. The connector according to claim 6, wherein
the cable includes an outer insulator and a plurality of signal lines disposed inside the outer insulator, and
the connecting element comprises a plurality of connecting elements, the connecting elements each including a two-forked tail to hold the each signal line between tines thereof so as to establish connection between the connecting elements and the signal lines.

19. The connector according to claim 7, wherein
the cable includes an outer insulator and a plurality of signal lines disposed inside the outer insulator, and
the connecting element comprises a plurality of connecting elements, the connecting elements each including a two-forked tail to hold the each signal line between tines thereof so as to establish connection between the connecting elements and the signal lines.

20. The connector according to claim 8, wherein
the cable includes an outer insulator and a plurality of signal lines disposed inside the outer insulator, and
the connecting element comprises a plurality of connecting elements, the connecting elements each including a two-forked tail to hold the each signal line between tines thereof so as to establish connection between the connecting elements and the signal lines.
